(19) United States
(12) Patent Application Publication
(10) Pub. No.: US 2022/0044338 A1
(43) Pub. Date: Feb. 10, 2022

(54) OPERATIONS AND MAINTENANCE DEVELOPMENT TOOL

(71) Applicant: Johnson Controls Technology Company, Auburn Hills, MI (US)

(72) Inventor: Jeffery Dean Smith, Jasper, GA (US)

(21) Appl. No.: 17/193,233

(22) Filed: Mar. 5, 2021

Related U.S. Application Data
(60) Provisional application No. 63/060,940, filed on Aug. 4, 2020.

(51) Int. Cl. G06Q 50/16; G06Q 10/00; G06Q 30/02; G06F 16/24

(52) U.S. Cl. CPC G06Q 50/163; G06F 16/24; G06Q 30/0283; G06Q 10/20

(57) ABSTRACT

Systems and apparatuses include a building energy usage improvement system including one or more memory devices configured to store instructions thereon that, when executed by one or more processors, cause the one or more processors to: generate a building architecture profile based on building information; query an energy profile database using the building architecture profile and receive an energy profile; query an energy allocation database using the building architecture profile and the energy profile, and receive a building subsystems benchmark; determine a benchmark maintenance profile based on the building architecture profile and the building subsystems benchmark; determine an improved maintenance profile using the building architecture profile and the benchmark maintenance profile; determine an improved building subsystems profile based on the improved maintenance profile; and determine an energy savings differential based on the improved building subsystems profile and the building subsystems benchmark.

### CROSS-REFERENCE TO RELATED PATENT APPLICATIONS

This application claims priority from U.S. Provisional Patent Application No. 63/060,940, filed Aug. 4, 2020, incorporated herein by reference in its entirety.

### TECHNICAL FIELD

The present disclosure relates to building operations and maintenance. More particularly, the present disclosure relates to systems and methods for improving energy efficiency and reducing greenhouse gas emissions via the use of a tool for providing improved operations and maintenance.

### BACKGROUND

Commercial buildings include heating, ventilation, and air conditioning systems and require service and repair. In addition routine maintained may be conducted to improve the operational efficiencies of equipment. Improvements in the operations and maintenance routines may lead to improvement in efficiency and other advantages.

### SUMMARY

One embodiment relates to a building energy usage improvement system that includes one or more memory devices configured to store instructions thereon that, when executed by one or more processors, cause the one or more processors to: receive building type information, building size information, building age information, and building location information; generate a building architecture profile based on the building type information, building size information, building age information, and building location information; query an energy profile database using the building architecture profile and receive an energy profile including estimated energy requirements; query an energy allocation database using the building architecture profile and the energy profile, and receive a building subsystems benchmark including a heating and cooling energy allocation; determine a benchmark maintenance profile based on the building architecture profile and the building subsystems benchmark, the benchmark maintenance profile including a preventative maintenance estimate, a reactive maintenance estimate, and a predictive maintenance estimate; determine an improved maintenance profile using the building architecture profile and the benchmark maintenance profile; determine an improved building subsystems profile based on the improved maintenance profile; and determine an energy savings differential based on the improved building subsystems profile and the building subsystems benchmark.

Another embodiment relates to a building maintenance improvement system that includes one or more memory devices configured to store instructions thereon that, when executed by one or more processors, cause the one or more processors to: receive building type information, building size information, building age information, and building location information; generate a building architecture profile based on the building type information, building size information, building age information, and building location information; query an energy profile database using the building architecture profile and receive an energy profile including estimated energy requirements; query an energy allocation database using the building architecture profile and the energy profile, and receive a building subsystems benchmark including a heating and cooling energy allocation; determine a benchmark maintenance profile based on the building architecture profile and the building subsystems benchmark, the benchmark maintenance profile including a preventative maintenance estimate, a reactive maintenance estimate, and a predictive maintenance estimate; determine an improved maintenance profile using the building architecture profile and the benchmark maintenance profile; query a labor database using the building architecture profile and the improved maintenance profile, and receive a labor hours requirement to achieve the improved maintenance profile; query a labor efficiency database using the labor hours requirement and a workforce factor, and receive a modified labor hour requirement; and assign a workforce to meet the modified labor hour requirement.

Another embodiment relates to a building maintenance improvement system that includes one or more memory devices configured to store instructions thereon that, when executed by one or more processors, cause the one or more processors to: receive building type information, building size information, building age information, and building location information; generate a building architecture profile based on the building type information, building size information, building age information, building location information, and building subsystem information; query an energy profile database using the building architecture profile and receive an energy profile including estimated energy requirements; query an energy allocation database using the building architecture profile and the energy profile, and receive a building subsystems benchmark including a heating and cooling energy allocation; determine a benchmark maintenance profile based on the building architecture profile and the building subsystems benchmark, the benchmark maintenance profile including a benchmark preventative maintenance estimate, a benchmark reactive maintenance estimate, and a benchmark predictive maintenance estimate; determine an improved maintenance profile using the building architecture profile and the benchmark maintenance profile, the improved maintenance profile including a target preventative maintenance percentage, a target reactive maintenance percentage, and a target predictive maintenance percentage; determine a smart system profile based on the improved maintenance profile, the smart system profile including a sensor installation list to achieve the improved maintenance profile; and identify a plurality of sensors to install based on the sensor installation list.

Another embodiment relates to a building energy usage improvement system that includes one or more memory devices configured to store instructions thereon that, when executed by one or more processors, cause the one or more processors to: receive building type information, building size information, building age information, and building location information; generate a building architecture profile based on the building type information, building size information, building age information, and building location information; query an energy profile database using the building architecture profile and receive an energy profile including estimated energy requirements; query an energy allocation database using the building architecture profile and the energy profile, and receive a building subsystems benchmark including a heating and cooling energy allocation; receive an equipment age of a heating ventilation and air conditioning equipment; determine an equipment energy allocation based on the building subsystems benchmark and the equipment age; query a lifecycle database using the equipment age and the equipment energy allocation and receive a lifecycle status including profitable, evaluation, diminishing returns, or replace; determine a recommendation for repair and maintenance, or replacement of the heating ventilation and air conditioning equipment; determine an improved building subsystems profile based on the recommendation; and determine an energy savings differential based on the improved building subsystems profile and the building sub systems benchmark.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of a building equipped with a heating, ventilation, and air conditioning (HVAC) system according to some embodiments.

FIG. 2 is a block diagram of a waterside system which can be used to serve the building of FIG. 1 according to some embodiments.

FIG. 3 is a block diagram of an airside system which can be used to serve the building of FIG. 1 according to some embodiments.

FIG. 4 is a block diagram of a building management system (BMS) which can be used to monitor and control the building of FIG. 1 according to some embodiments.

FIG. 5 is a block diagram of another BMS which can be used to monitor and control the building of FIG. 1 according to some embodiments.

FIG. 6 is a schematic diagram of a controller for improving the operations and maintenance of the building of FIG. 1 according to some embodiments.

FIG. 7 is a graph showing a lifecycle of HVAC equipment according to some embodiments.

FIG. 8 is a flow chart representing information stored in a labor efficiency database of the controller of FIG. 6 according to some embodiments.

### DETAILED DESCRIPTION

Following below are more detailed descriptions of various concepts related to, and implementations of, methods, apparatuses, and systems for improving building energy usage by providing improved operations and maintenance. Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Building HVAC Systems and Building Management Systems

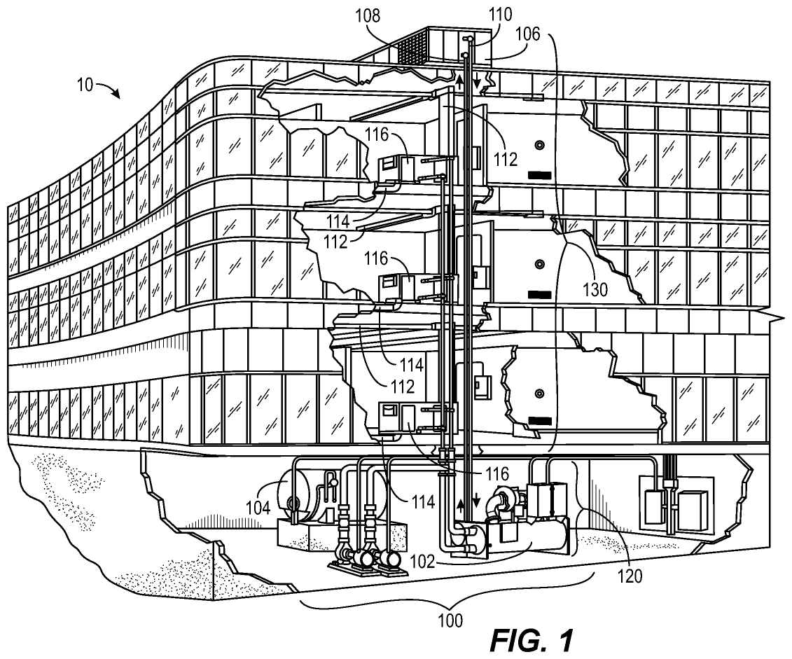

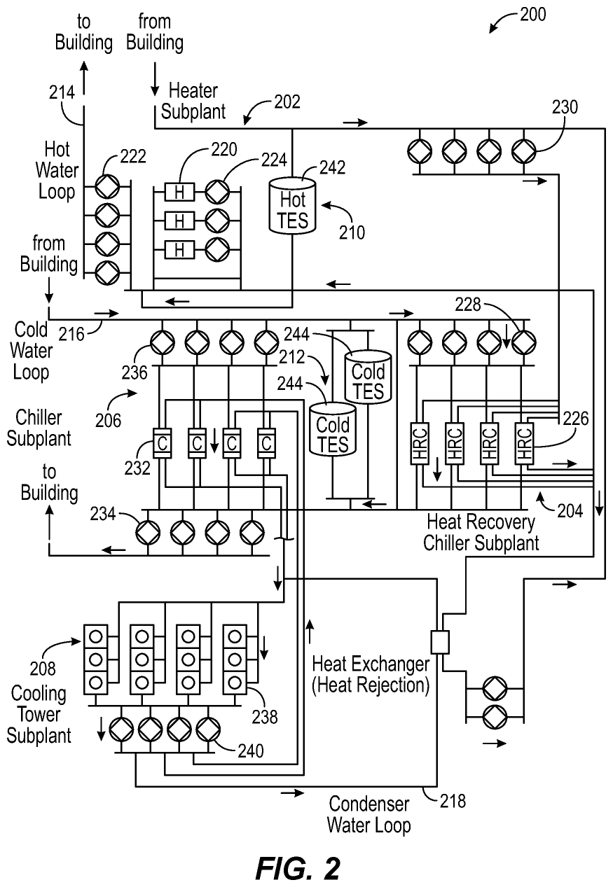

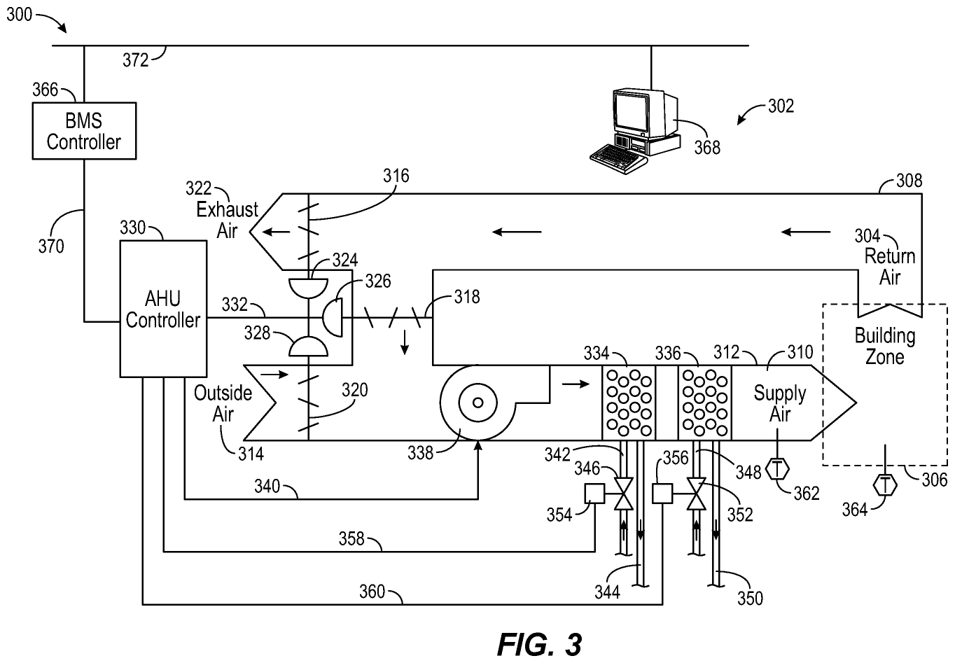

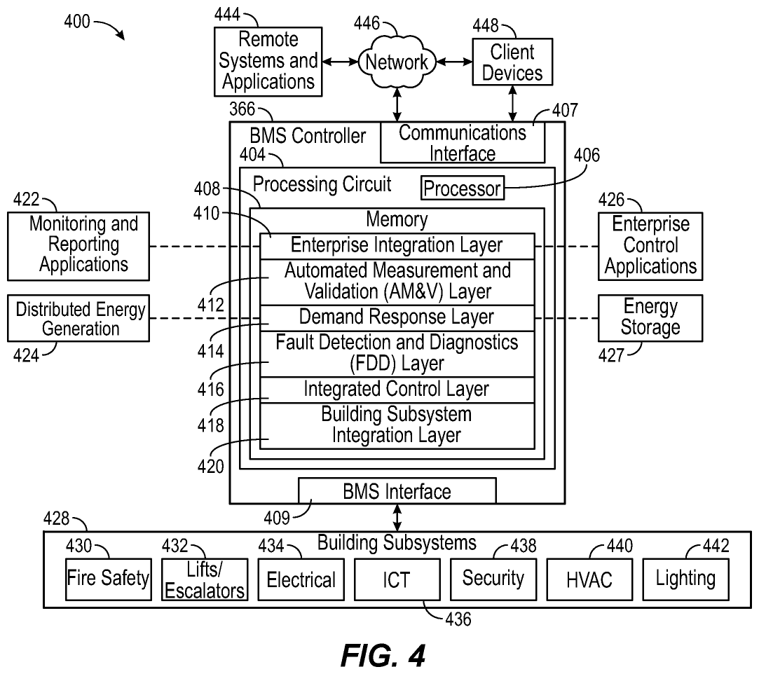

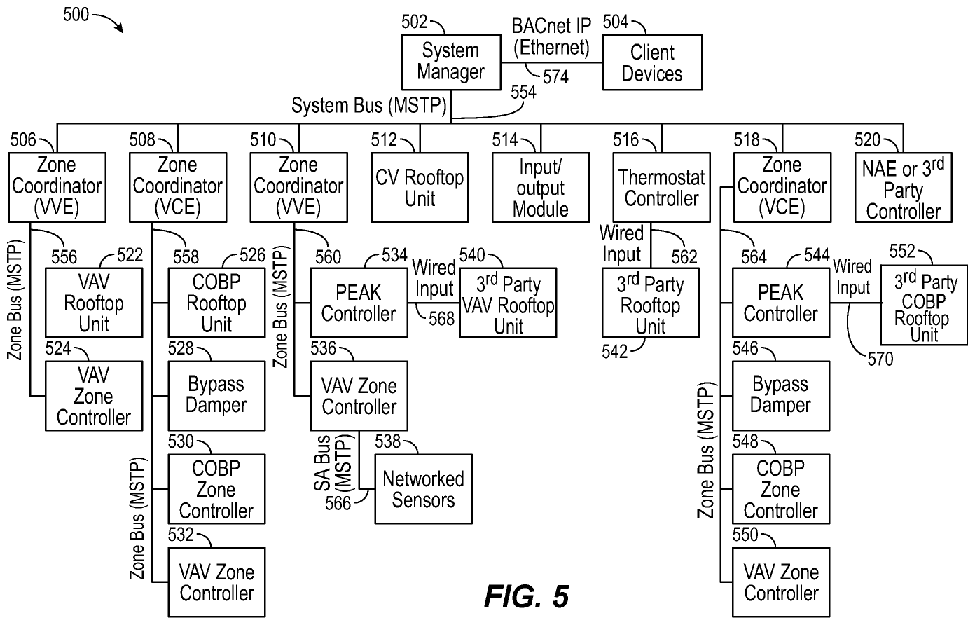

Referring now to FIGS. 1-5, several building management systems (BMS) and HVAC systems in which the systems and methods of the present disclosure can be implemented are shown, according to some embodiments. In brief overview, FIG. 1 shows a building 10 (e.g., a hospital) equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10. FIG. 5 is a block diagram of another BMS which can be used to monitor and control building 10.

Building and HVAC System

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Waterside System

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

Building Management Systems

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML, files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

Referring now to FIG. 5, a block diagram of another building management system (BMS) 500 is shown, according to some embodiments. BMS 500 can be used to monitor and control the devices of HVAC system 100, waterside system 200, airside system 300, building subsystems 428, as well as other types of BMS devices (e.g., lighting equipment, security equipment, etc.) and/or HVAC equipment.

As shown in FIG. 5, a BMS 500 provides a system architecture that facilitates automatic equipment discovery and equipment model distribution. Equipment discovery can occur on multiple levels of BMS 500 across multiple different communications busses (e.g., a system bus 554, zone buses 556-560 and 564, sensor/actuator bus 566, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 500 can begin interacting with the new device (e.g., sending control signals, using data from the device) without user interaction.

Some devices in BMS 500 present themselves to the network using equipment models.

An equipment model defines equipment object attributes, view definitions, schedules, trends, and the associated BACnet value objects (e.g., analog value, binary value, multistate value, etc.) that are used for integration with other systems. Some devices in BMS 500 store their own equipment models. Other devices in BMS 500 have equipment models stored externally (e.g., within other devices). For example, a zone coordinator 508 can store the equipment model for a bypass damper 528. In some embodiments, zone coordinator 508 automatically creates the equipment model for bypass damper 528 or other devices on zone bus 558. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 5, BMS 500 is shown to include a system manager 502; several zone coordinators 506, 508, 510 and 518; and several zone controllers 524, 530, 532, 536, 548, and 550. System manager 502 can monitor data points in BMS 500 and report monitored variables to various monitoring and/or control applications. System manager 502 can communicate with client devices 504 (e.g., user devices, desktop computers, laptop computers, mobile devices, etc.) via a data communications link 574 (e.g., BACnet IP, Ethernet, wired or wireless communications, etc.). System manager 502 can provide a user interface to client devices 504 via data communications link 574. The user interface may allow users to monitor and/or control BMS 500 via client devices 504.

In some embodiments, system manager 502 is connected with zone coordinators 506-510 and 518 via a system bus 554. System manager 502 can be configured to communicate with zone coordinators 506-510 and 518 via system bus 554 using a master-slave token passing (MSTP) protocol or any other communications protocol. System bus 554 can also connect system manager 502 with other devices such as a constant volume (CV) rooftop unit (RTU) 512, an input/output module (IOM) 514, a thermostat controller 516 (e.g., a TEC5000 series thermostat controller), and a network automation engine (NAE) or third-party controller 520. RTU 512 can be configured to communicate directly with system manager 502 and can be connected directly to system bus 554. Other RTUs can communicate with system manager 502 via an intermediate device. For example, a wired input 562 can connect a third-party RTU 542 to thermostat controller 516, which connects to system bus 554.

System manager 502 can provide a user interface for any device containing an equipment model. Devices such as zone coordinators 506-510 and 518 and thermostat controller 516 can provide their equipment models to system manager 502 via system bus 554. In some embodiments, system manager 502 automatically creates equipment models for connected devices that do not contain an equipment model (e.g., IOM 514, third party controller 520, etc.). For example, system manager 502 can create an equipment model for any device that responds to a device tree request. The equipment models created by system manager 502 can be stored within system manager 502. System manager 502 can then provide a user interface for devices that do not contain their own equipment models using the equipment models created by system manager 502. In some embodiments, system manager 502 stores a view definition for each type of equipment connected via system bus 554 and uses the stored view definition to generate a user interface for the equipment.

Each zone coordinator 506-510 and 518 can be connected with one or more of zone controllers 524, 530-532, 536, and 548-550 via zone buses 556, 558, 560, and 564. Zone coordinators 506-510 and 518 can communicate with zone controllers 524, 530-532, 536, and 548-550 via zone busses 556-560 and 564 using a MSTP protocol or any other communications protocol. Zone busses 556-560 and 564 can also connect zone coordinators 506-510 and 518 with other types of devices such as variable air volume (VAV) RTUs 522 and 540, changeover bypass (COBP) RTUs 526 and 552, bypass dampers 528 and 546, and PEAK controllers 534 and 544.

Zone coordinators 506-510 and 518 can be configured to monitor and command various zoning systems. In some embodiments, each zone coordinator 506-510 and 518 monitors and commands a separate zoning system and is connected to the zoning system via a separate zone bus. For example, zone coordinator 506 can be connected to VAV RTU 522 and zone controller 524 via zone bus 556. Zone coordinator 508 can be connected to COBP RTU 526, bypass damper 528, COBP zone controller 530, and VAV zone controller 532 via zone bus 558. Zone coordinator 510 can be connected to PEAK controller 534 and VAV zone controller 536 via zone bus 560. Zone coordinator 518 can be connected to PEAK controller 544, bypass damper 546, COBP zone controller 548, and VAV zone controller 550 via zone bus 564.

A single model of zone coordinator 506-510 and 518 can be configured to handle multiple different types of zoning systems (e.g., a VAV zoning system, a COBP zoning system, etc.). Each zoning system can include a RTU, one or more zone controllers, and/or a bypass damper. For example, zone coordinators 506 and 510 are shown as Verasys VAV engines (VVEs) connected to VAV RTUs 522 and 540, respectively. Zone coordinator 506 is connected directly to VAV RTU 522 via zone bus 556, whereas zone coordinator 510 is connected to a third-party VAV RTU 540 via a wired input 568 provided to PEAK controller 534. Zone coordinators 508 and 518 are shown as Verasys COBP engines (VCEs) connected to COBP RTUs 526 and 552, respectively. Zone coordinator 508 is connected directly to COBP RTU 526 via zone bus 558, whereas zone coordinator 518 is connected to a third-party COBP RTU 552 via a wired input 570 provided to PEAK controller 544.

Zone controllers 524, 530-532, 536, and 548-550 can communicate with individual BMS devices (e.g., sensors, actuators, etc.) via sensor/actuator (SA) busses. For example, VAV zone controller 536 is shown connected to networked sensors 538 via SA bus 566. Zone controller 536 can communicate with networked sensors 538 using a MSTP protocol or any other communications protocol. Although only one SA bus 566 is shown in FIG. 5, it should be understood that each zone controller 524, 530-532, 536, and 548-550 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 524, 530-532, 536, and 548-550 can be configured to monitor and control a different building zone. Zone controllers 524, 530-532, 536, and 548-550 can use the inputs and outputs provided via their SA busses to monitor and control various building zones. For example, a zone controller 536 can use a temperature input received from networked sensors 538 via SA bus 566 (e.g., a measured temperature of a building zone) as feedback in a temperature control algorithm. Zone controllers 524, 530-532, 536, and 548-550 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

Benchmarking, Operations and Maintenance Development System

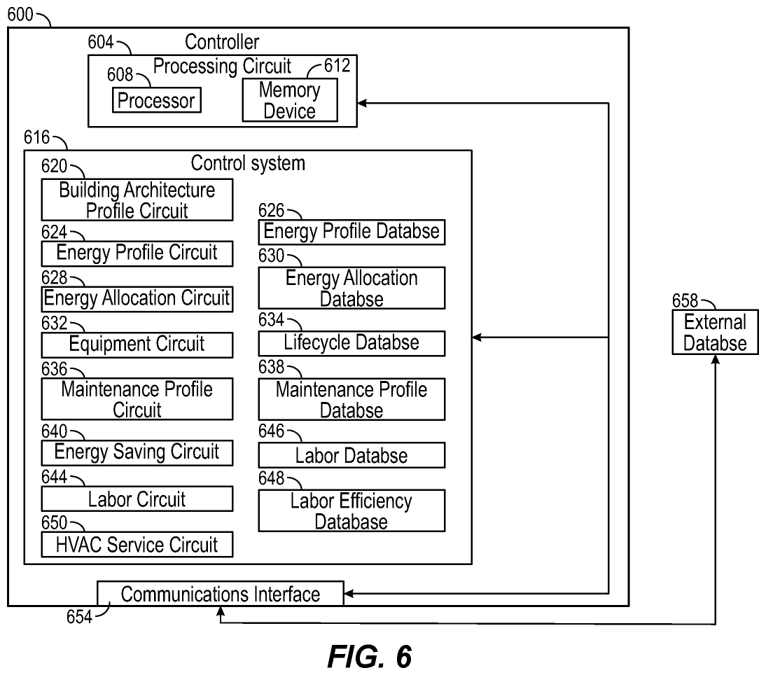

As shown in FIG. 6, a controller 600 is generally structured to benchmark an energy usage of heating, ventilation, and air conditioning systems of a building based on limited inputs by using various databases to provide accurate estimates of a buildings usage. Using the benchmark, systems described herein develop recommendations for improved system for operations and maintenance (O&M) programs and equipment refresh, repair, and/or replacement to improve energy consumption and reduce greenhouse gas emissions. Additionally, systems described herein provide an automated means of determining an optimal workforce and organizing the workforce over a large scale O&M program to improve workforce utilization and improve energy consumption

As the components of FIGS. 1-5 are shown to be embodied in the building 10, the controller 600 may be structured as one or more building automation systems (BAS) either as a part of or separate from the BAS described above. The function and structure of the controller 600 is described in greater detail in FIG. 6.

Referring now to FIG. 6, a schematic diagram of the controller 600 of the building 10 of FIG. 1 is shown according to an example embodiment. As shown in FIG. 6, the controller 600 includes a processing circuit 604 having a processor 608 and a memory device 612, a control system 616 having a building architecture profile circuit 620, an energy profile circuit 624, an energy profile database 626, an energy allocation circuit 628, an energy allocation database 630, an equipment circuit 632, a lifecycle database 634, a maintenance profile circuit 636, a maintenance profile database 638, an energy saving circuit 640, a labor circuit 644, a labor database 646, a labor efficiency database 648, an HVAC service circuit 650, and a communications interface 654.

building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650

In one configuration, the building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650 are embodied as machine or computer-readable media that is executable by a processor, such as processor 608. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650 are embodied as hardware units, such as electronic control units. As such, the building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650 may be embodied as one or more circuitry components including, but not limited to, processing circuitry, network interfaces, peripheral devices, input devices, output devices, sensors, etc. In some embodiments, the building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650 may also include programmable hardware devices such as field programmable gate arrays, programmable array logic, programmable logic devices or the like. The building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650 may include one or more memory devices for storing instructions that are executable by the processor(s) of the building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650. The one or more memory devices and processor(s) may have the same definition as provided below with respect to the memory device 612 and processor 608. In some hardware unit configurations, the building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650 may be geographically dispersed throughout separate locations in the building 10 or be located remote of the building 10 either together or separately. Alternatively and as shown, the building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650 may be embodied in or within a single unit/housing, which is shown as the controller 600.

In the example shown, the controller 600 includes the processing circuit 604 having the processor 608 and the memory device 612. The processing circuit 604 may be structured or configured to execute or implement the instructions, commands, and/or control processes described herein with respect to building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650. The depicted configuration represents the building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650 as machine or computer-readable media. However, as mentioned above, this illustration is not meant to be limiting as the present disclosure contemplates other embodiments where the building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650, or at least one circuit of the building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650, is configured as a hardware unit. All such combinations and variations are intended to fall within the scope of the present disclosure.

The hardware and data processing components used to implement the various processes, operations, illustrative logics, logical blocks, modules and circuits described in connection with the embodiments disclosed herein (e.g., the processor 608) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 612 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 612 may be communicably connected to the processor 608 to provide computer code or instructions to the processor 608 for executing at least some of the processes described herein. Moreover, the memory device 612 may be or include tangible, non-transient volatile memory or non-volatile memory. Accordingly, the memory device 612 may include database components, object code components, script components, or any other type of information structure for supporting the various activities and information structures described herein.

The databases described herein may include local databases including information saved and assembled within the memory device 612, external databases 658, or a combination of local databases and external databases 658. In some embodiments, the external databases 658 include The U.S. EIA, ACEE, ASHRAE, DOE, NREL, FEMP, NxGen, BOMA, IFMA, FM Benchmarking, WhiteStone, ASME, and/or PNNL. In some embodiments, additional databases are included or used, or some databases may be eliminated. In some embodiments, an external database 658 may provide raw information that is modified by a local database for use by the controller 600. Additionally, one or more of the energy profile database 626, the energy allocation database 630, the lifecycle database 634, the maintenance profile database 638, the labor database 646, and the labor efficiency database 648 can be combined within a single database. The databases may be updated on a multiyear schedule and the databases may update raw external database 658 information with an algorithm accounting for yearly increases or changes.

The building architecture profile circuit 620 is structured to receive information via user input. In some embodiments, the building architecture profile circuit 620 is structured to receive information from a user device such as a hand held device, a smartphone, a tablet, a computer, or another peripheral device or human machine interface. The information received by the building architecture profile circuit 620 includes building type information, building size information, building age information, building location information, and building subsystem age.

The building type information identifies a category that defines the uses of a building such as the building 10. In some embodiments, the building discussed herein is arranged differently than the building 10. The building 10 is merely one exemplary building to which the systems described herein may pertain. In some embodiments, the building type information includes education (e.g., college or university, K-12, elementary or middle school, high school, preschool or daycare, other classroom education), food sales (e.g., convenience store, grocery store or food market, other food sales), food service (e.g., fast food, restaurant or cafeteria, bar, pub, or lounge, other food service), health care (e.g., inpatient, outpatient, office, clinic or other outpatient), lodging (e.g., hotel, motel or inn, dormitory, fraternity, or sorority, nursing home or assisted living, other lodging), mercantile (e.g., retail, vehicle dealership, other retail), enclosed and strip malls (e.g., strip shopping center, enclosed mall), office (e.g., administrative or professional, bank or other financial, government, medical, mixed-use, other office), public assembly (e.g., library, entertainment or culture, recreation, social or meeting, other assembly), public order and safety (e.g., fire or police station, courthouse or probation office, other public order, religious worship), service (e.g., post office or postal center, repair shop, vehicle service or repair, vehicle storage or maintenance, other service), warehouse and storage (e.g., nonrefrigerated, warehouse, distribution or shipping center, self-storage units, refrigerated, other), laboratory, or vacant. The building type information allows the controller 600 to identify relevant energy usage statistics.

The building size information includes square footage or building volume of the building 10. The building age information includes when the building was constructed or last fully remodeled including all utilities. Generally, the building age information will be the construction date of the building 10. The building location information includes identifying geographic information such as zip code, GPS coordinates, city, state, and/or municipality. The building subsystem age includes details of a particular piece of equipment (e.g., a cooler or air handling unit). In some embodiments, the building subsystem age may provide aging related information about an entire subsystem. For example, a date when a cooling system was replaced (e.g., 10 years ago) may be included in the building subsystem age information.

The building architecture profile circuit 620 is further structured to determine or generate a building architecture profile based on the building size information, the building age information, the building location information, and the building subsystem age. In some embodiments, one or more of the building size information, the building age information, the building location information, and/or the building subsystem age may be eliminated from the process for determining the building architecture profile. The building architecture profile defines HVAC and other utilities (e.g., fire suppression system, security, etc) of the building 10. In some embodiments, the building architecture profile makes assumptions based on the received information. For example, a hospital of a certain square footage in Atlanta, Ga. that is 26 years old, and had a recommissioning of the boiler system 10 years ago will result in a building architecture profile of an assumed number of chillers, AHUs, boilers, etc. and the assumptions are reflected in the building architecture profile. In some embodiments, the building architecture profile circuit 620 uses an external database 658 to generate the building architecture profile.

The energy profile circuit 624 is structured to query the energy profile database 626 using the building architecture profile, and receive an energy profile from the energy profile database 626 that includes electrical usage per square foot, electrical utility cost per unit, electrical cost per square foot, total annual electrical cost, fossil fuel usage per square foot (e.g., natural gas), fossil fuel utility cost per unit, fossil fuel cost per square foot, total annual fossil fuel cost, steam usage per square foot, steam utility cost per unit, steam cost per square foot, total annual steam cost, water usage per square foot, water utility cost per unit, water cost per square foot, total annual water cost, and total annual utility cost. In some embodiments, one or more of the above listed information are eliminated.

The energy profile database 626 may coordinate and/or combine information from multiple external databases 658 to generate the energy profile that fits the building architecture profile. For example, the energy profile database 626 may receive information from one or more local utilities and the U.S. EIA and process the received information to provide the pertinent information.

The energy allocation circuit 628 is structured to query the energy allocation database 630 using the building architecture profile and the energy profile and receive a building subsystems benchmark that includes information about how much of the energy defined within the energy profile is used by various systems within the building. In some embodiments, the building subsystems benchmark breaks down allocations of energy within the categories of electricity, fossil fuels (e.g., natural gas), and water. In some embodiments, the electrical allocation is divided into energy used by computers, cooking, cooling, lighting, office equipment, miscellaneous, refrigeration, heating, ventilation, and water heating. In some embodiments, the fossil fuels allocation is divided into energy used by cooking, heating, other, and water heating. In some embodiments, the water allocation is divided into water used by cooling/heating, domestic/restroom, kitchen, irrigation, and other.

Once the building subsystems benchmark is established, the energy allocation circuit 628 identifies target energy allocations for improvement. For example, energy allocations affected by HVAC systems within the building 10 are targeted and the energy allocation circuit 628 determines a heating energy allocation including all energy sources and resources used to provide heat, and a cooling energy allocation including all energy sources and resources used to provide cooling. In some embodiments, other allocations may be provided. For example, a ventilation allocation, a humidity allocation, an air quality allocation, etc.

The energy allocation database 630 may receive information from multiple external databases 658 to provide relative percentages of energy usage within different categories or allocations. For example, the following table provides an exemplary building subsystems benchmark:

| Loads | Municipality |
|---|---|
| Computers | 10% |
| Cooking | 0% |
| Cooling | 14% |
| Lighting | 39% |
| Office Equip. | 4% |
| Misc. | 13% |
| Refrigeration | 5% |
| Heating E | 5% |
| Ventilation | 9% |
| Water Heating E | 1% |

The equipment circuit 632 is structured to determine a benchmark operational efficiency based on the building subsystem age. The benchmark operational efficiency is representative of average or typical operation energy usage, O&M resources, and other requirements associated with keeping the subsystems of the building operational. Based on the building subsystem age and in some cases other information (e.g., the building architecture profile) an accurate estimate can be made with the benchmark operational efficiency.

Once the benchmark operational efficiency is determined, a replacement operational efficiency can be generated on a system by system basis or on a whole system level to determine efficiencies that can be gained by making capital investments to replace existing equipment. The equipment circuit 632 can analyze the benchmark operational efficiency and the replacement operational efficiency to determine a return on investment type analysis and determine if replacement of the equipment provides an economical, and environmental, and/or an O&M advantage.

In some embodiments, the equipment circuit 632 is structured to receive an equipment list representing the actual equipment installed in the building. The equipment list can be generated manually via inspection, or received by the equipment circuit 632 from an external database 658. In some embodiments, the equipment list includes centrifugal chillers, reciprocating chillers, air cooled scroll chillers, screw chillers, absorption chillers, boilers, centrifugal water pumps, cooling towers, heat exchangers, fan coil units, exterior exhaust fans, roof top units, CRAC units, split systems (e.g., HP), AHU's, and air cooled condensers. In some embodiments, details are provided for each piece of equipment including model and serial numbers, commission date, and service records. Utilization of the equipment list allows for more accurate estimates within the benchmark operational efficiency.

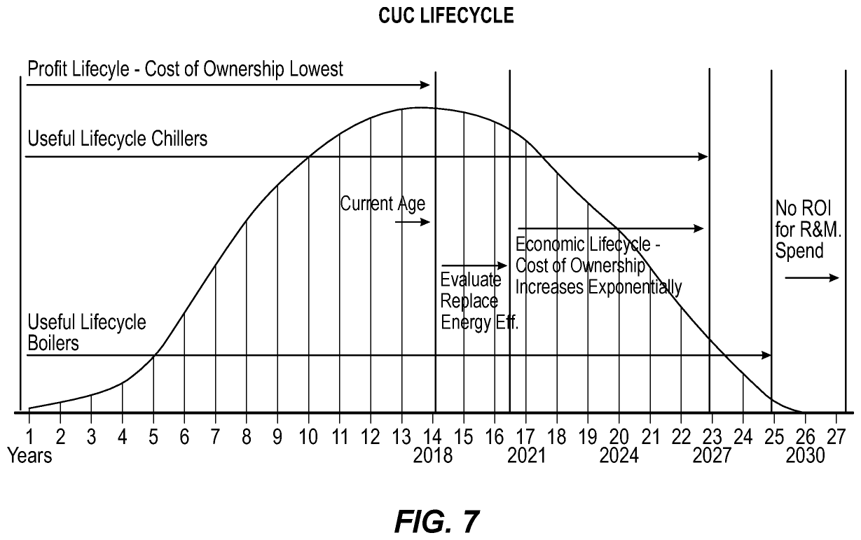

In some embodiments, the equipment circuit 632 is structured to provide a recommended replacement time frame for a piece of equipment based on the benchmark operational efficiency and the replacement operational efficiency. For example, as shown in FIG. 7, each piece of equipment has a defined lifecycle that closely follows a time scale. The equipment circuit 632 is structured to receive an equipment age of a heating ventilation and air conditioning equipment, determine an equipment energy allocation based on the building subsystems benchmark and the equipment age, query the lifecycle database 634 using the equipment age and the equipment energy allocation and receive a lifecycle status including profitable, evaluation, diminishing returns, or replace. As shown in FIG. 7, the profitable status is provided during the time defined as the profit lifecycle. During this time period, the cost to own and maintain is lowest and the equipment is operating at peak efficiency. The evaluation status is provided after the profit lifecycle has ended and during the evaluation status a refresh or repair may still be more advantageous (e.g., economically, environmentally) than replacement. The diminishing returns status is provided after the evaluation status and defines a time period where O&M costs will make the equipment less advantageous and timing for replacement should be examined closely. The replace status is provided after the diminishing returns status and indicates that the equipment should be replaced as soon as feasible to improve the efficiency and resource usage of the equipment.

Based on the lifecycle status, the equipment circuit 632 determines a recommendation for repair and maintenance, or replacement of the heating ventilation and air conditioning equipment. In some embodiments, the recommended replacement time frame is less than the useful lifecycle of the equipment (e.g., before the replace status is generated). Once the recommended replacement time frame is established, the equipment circuit 632 determines an improved building subsystems profile based on the recommendation, and then determines an energy savings differential based on the improved building subsystems profile and the building subsystems benchmark. The energy savings differential indicates a cost savings, a greenhouse gas emissions reduction, or another advantageous attribute achieved by implementing the improved building subsystems profile.

The lifecycle database 634 is structured to estimate a projected useful life of a piece of equipment and to return the lifecycle status based on the equipment age. In some embodiments, the lifecycle database 634 accounts for more details including service record or usage rate in the determination of the lifecycle status.

The maintenance profile circuit 636 is structured to query a maintenance profile database 638 and receive a benchmark maintenance profile based on the building architecture profile and the building subsystems benchmark. The benchmark maintenance profile includes a preventative maintenance estimate, a reactive maintenance estimate, and a predictive maintenance estimate. Preventive maintenance can be defined as actions performed on a time- or machine-run-based schedule that detect, preclude, or mitigate degradation of a component or system with the aim of sustaining or extending its useful life through controlling degradation to an acceptable level. Reactive maintenance includes no actions or efforts are taken to maintain the equipment as the designer originally intended to ensure design life is reached. Reactive maintenance only fixes issues as they arise. Predictive maintenance can be defined as a program that uses measurements that detect the onset of system degradation (lower functional state), thereby allowing causal stressors to be eliminated or controlled prior to any significant deterioration in the component physical state. Results indicate current and future functional capability. The preventative maintenance estimate, the reactive maintenance estimate, and the predictive maintenance estimate may be provided as a percentage of maintenance indicative of the typical O&M plan associated with the building architecture profile and the building subsystems benchmark.

The maintenance profile circuit 636 is structured to determine an improved maintenance profile using the building architecture profile and the benchmark maintenance profile that includes a target preventative maintenance percentage, a target reactive maintenance percentage, and a target predictive maintenance percentage. For example, the target predictive maintenance percentage may be larger than the benchmark preventative maintenance estimate.

An improved building subsystems profile is then determined based on the improved maintenance profile and includes recommendations for equipment specific changes to O&M procedures or routines. For example, maintenance may be based on measurements rather than strict schedules or equipment upgrades may be recommended. In some embodiments, a smart system profile is determined based on the improved maintenance profile and includes a sensor installation list received from the maintenance profile database 638 to allow the building 10 to achieve the improved maintenance profile. The sensor installation list identifies a plurality of sensors to install on HVAC equipment. In some embodiments, the sensor list includes vibration monitoring/analysis, oil analysis (wear particulate/contamination), water chemistry analysis), bearing temperature/analysis, performance monitoring, ultrasonic noise detection, ultrasonic flow, infrared thermography, delta-T-delta P monitoring/analysis, visual inspection, motor insulation resistance, motor current signature analysis, and/or flu gas analysis. Each piece of equipment is provided with a sensor list that is relevant to the operations of the equipment and the dictations of the improved maintenance profile.

The energy saving circuit 640 is structured to determine an energy savings differential based on the improved building subsystems profile and the building subsystems benchmark, and determine a benchmark greenhouse gas emissions, an improved greenhouse gas emissions, and a greenhouse gas emissions reduction. The energy saving differential and the greenhouse gas emissions reduction represent the improvements that are made by implementing the recommendations of the controller 600.

The labor circuit 644 is structured to query the labor database 646 using the building architecture profile and the improved maintenance profile and receive a labor hours requirement to achieve the improved maintenance profile. The labor database 646 includes algorithms and information indicative of the O&M manual resources required to implement the improved maintenance profile so that the required human resources can be accurately generated.

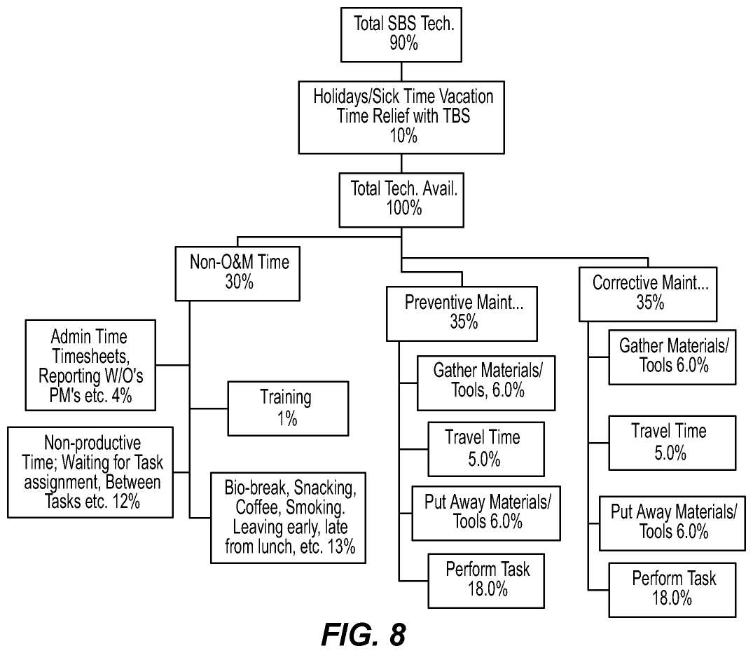

Once the labor hours requirement is received from the labor database 646, the labor circuit 644 queries the labor efficiency database 648 (see FIG. 8) using the labor hours requirement and a workforce factor, and receives a modified labor hour requirement. As shown in FIG. 8, the modified labor hours requirement accounts for the inefficiencies inherent to a workforce. Additionally, the workforce factor can account for industry differences, geographic influences, or other factors that affect the O&M workforce efficiency. In some embodiments, the modified labor hours requirement is divided into segments including a chiller hours requirement (heavy and light), a mechanical hours requirement (heavy and light), and a controls hours requirement. In some embodiments, the segments require different personnel and the segments allow for a more accurate and skillful deployment of the workforce.

The labor circuit 644 is structured to assign a workforce to meet the modified labor hour requirement and generate a workforce schedule to achieve the improved maintenance profile. The workforce schedule can integrate an existing workforce and an improved maintenance workforce, replace the existing workforce, or repurpose the existing workforce to more effectively implement the improved maintenance profile.

The HVAC service circuit 650 is structured to determine the existing O&M and capital costs of the building 10 based on the existing building infrastructure and organize a HVAC service that includes O&M and capital costs as an integrated service structure. In some embodiments, no equipment cost is included in the integrated service structure. The utilization of the integrated service structure can be advantageous to reduce energy consumption and the emissions of greenhouse gases because it allows for the full utilization of the improved profiles discussed above.

The controller 600 allows the integration of information from a large number of external databases 658 into a tool allowing the reduction of energy consumption and emissions of greenhouse gases. The controller 600 provides automatic generation of improvement recommendation, maintenance schedules, and improves the efficiency of human resources. The improvements eliminate the inefficient replacement and repair of equipment and thereby makes more efficient use of limited resources (e.g., fuel, parts, and human time).

In some embodiments, the controller 600 is integrated with a human machine interface in the form of an application within a tablet, handheld, or other computing device. The profiles, schedules, and other outputs of the controller 600 can be automatically produced and updated to provide up to date information for use by an O&M manager or team. The controller 600 provides for improved communication between O&M team members of the workforce and improves the efficiency of workforce time.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIG. 6, it should be understood that the controller 600 may include any number of circuits for completing the functions described herein. For example, the activities and functionalities of the building architecture profile circuit 620, the energy profile circuit 624, the energy profile database 626, the energy allocation circuit 628, the energy allocation database 630, the equipment circuit 632, the lifecycle database 634, the maintenance profile circuit 636, the maintenance profile database 638, the energy saving circuit 640, the labor circuit 644, the labor database 646, the labor efficiency database 648, and the HVAC service circuit 650 may be combined in multiple circuits or as a single circuit. Additional circuits with additional functionality may also be included. Further, the controller 600 may further control other activity beyond the scope of the present disclosure.

As mentioned above and in one configuration, the “circuits” may be implemented in machine-readable medium for execution by various types of processors, such as the processor 608 of FIG. 6. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the controller 600, building 10 and other system and subsystems as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A building energy usage improvement system comprising:
one or more memory devices configured to store instructions thereon that, when executed by one or more processors, cause the one or more processors to:
receive building type information, building size information, building age information, and building location information;
generate a building architecture profile based on the building type information, building size information, building age information, and building location information;
query an energy profile database using the building architecture profile and receive an energy profile including estimated energy requirements;
query an energy allocation database using the building architecture profile and the energy profile, and receive a building subsystems benchmark including a heating and cooling energy allocation;
determine a benchmark maintenance profile based on the building architecture profile and the building subsystems benchmark, the benchmark maintenance profile including a preventative maintenance estimate, a reactive maintenance estimate, and a predictive maintenance estimate;
determine an improved maintenance profile using the building architecture profile and the benchmark maintenance profile;
determine an improved building subsystems profile based on the improved maintenance profile; and
determine an energy savings differential based on the improved building subsystems profile and the building subsystems benchmark.

2. The building energy usage improvement system of claim 1, wherein the energy profile database and the energy allocation database are combined within a single database.

3. The building energy usage improvement system of claim 1, wherein the improved maintenance profile includes a target preventative maintenance percentage, a target reactive maintenance percentage, and a target predictive maintenance percentage.

4. The building energy usage improvement system of claim 1, wherein the one or more memory devices are further configured to store instructions thereon that, when executed by the one or more processors, cause the one or more processors to:
query a labor database using the building architecture profile and the improved maintenance profile, and receive a labor hours requirement to achieve the improved maintenance profile;
query a labor efficiency database using the labor hours requirement and a workforce factor, and receive a modified labor hour requirement; and
assign a workforce to meet the modified labor hour requirement

5. The building energy usage improvement system of claim 1, wherein the one or more memory devices are further configured to store instructions thereon that, when executed by the one or more processors, cause the one or more processors to:
determine a smart system profile based on the improved maintenance profile, the smart system profile including a sensor installation list to achieve the improved maintenance profile; and
identify a plurality of sensors to install based on the sensor installation list.

6. The building energy usage improvement system of claim 1, wherein the building architecture profile includes a building subsystem age;
wherein the one or more memory devices are further configured to store instructions thereon that, when executed by the one or more processors, cause the one or more processors to:
determine a benchmark operational efficiency based on the building subsystem age;
determine a replacement operational efficiency;
provide a recommended replacement time frame based on the benchmark operational efficiency and the replacement operational efficiency.

7. The building energy usage improvement system of claim 6, wherein the recommended replacement time frame is less than the useful lifecycle of a corresponding building subsystem.

8. The building energy usage improvement system of claim 1, wherein the energy savings differential includes a greenhouse gas emissions reduction.

9. A building maintenance improvement system comprising:
one or more memory devices configured to store instructions thereon that, when executed by one or more processors, cause the one or more processors to:
receive building type information, building size information, building age information, and building location information;
generate a building architecture profile based on the building type information, building size information, building age information, and building location information;
query an energy profile database using the building architecture profile and receive an energy profile including estimated energy requirements;
query an energy allocation database using the building architecture profile and the energy profile, and receive a building subsystems benchmark including a heating and cooling energy allocation;
determine a benchmark maintenance profile based on the building architecture profile and the building subsystems benchmark, the benchmark maintenance profile including a preventative maintenance estimate, a reactive maintenance estimate, and a predictive maintenance estimate;
determine an improved maintenance profile using the building architecture profile and the benchmark maintenance profile;
query a labor database using the building architecture profile and the improved maintenance profile, and receive a labor hours requirement to achieve the improved maintenance profile;
query a labor efficiency database using the labor hours requirement and a workforce factor, and receive a modified labor hour requirement; and
assign a workforce to meet the modified labor hour requirement.

10. The building maintenance improvement system of claim 9, wherein one or more of the energy profile database, the energy allocation database, the labor database, and the labor efficiency database are combined within a single database.

11. The building maintenance improvement system of claim 9, wherein the one or more memory devices are further configured to store instructions thereon that, when executed by the one or more processors, cause the one or more processors to:
determine a chiller hours requirement based on the modified labor hour requirement,
determine a mechanical hours requirement based on the modified labor hour requirement, and
determine a controls hours requirement based on the modified labor hour requirement.

12. The building maintenance improvement system of claim 11, wherein the workforce includes individual allocations to meet each of the chiller hours requirement, the mechanical hours requirement, and the controls hours requirement separately.

13. The building maintenance improvement system of claim 9, wherein the one or more memory devices are further configured to store instructions thereon that, when executed by the one or more processors, cause the one or more processors to:
determine a smart system profile based on the improved maintenance profile, the smart system profile including a sensor installation list to achieve the improved maintenance profile; and
identify a plurality of sensors to install based on the sensor installation list.

14. The building maintenance improvement system of claim 9, wherein the building architecture profile includes a building subsystem age;
wherein the one or more memory devices are further configured to store instructions thereon that, when executed by the one or more processors, cause the one or more processors to:
determine a benchmark operational efficiency based on the building subsystem age;
determine a replacement operational efficiency;
provide a recommended replacement time frame based on the benchmark operational efficiency and the replacement operational efficiency.

15. The building maintenance improvement system of claim 9, wherein the one or more memory devices are further configured to store instructions thereon that, when executed by the one or more processors, cause the one or more processors to:
generate a workforce schedule to achieve the improved maintenance profile.

16. The building maintenance improvement system of claim 9, wherein the workforce schedule integrates an existing workforce and an improved maintenance workforce.

17. A building maintenance improvement system comprising:
one or more memory devices configured to store instructions thereon that, when executed by one or more processors, cause the one or more processors to:
receive building type information, building size information, building age information, and building location information;
generate a building architecture profile based on the building type information, building size information, building age information, building location information, and building subsystem information;
query an energy profile database using the building architecture profile and receive an energy profile including estimated energy requirements;
query an energy allocation database using the building architecture profile and the energy profile, and receive a building subsystems benchmark including a heating and cooling energy allocation;
determine a benchmark maintenance profile based on the building architecture profile and the building subsystems benchmark, the benchmark maintenance profile including a benchmark preventative maintenance estimate, a benchmark reactive maintenance estimate, and a benchmark predictive maintenance estimate;
determine an improved maintenance profile using the building architecture profile and the benchmark maintenance profile, the improved maintenance profile including a target preventative maintenance percentage, a target reactive maintenance percentage, and a target predictive maintenance percentage;
determine a smart system profile based on the improved maintenance profile, the smart system profile including a sensor installation list to achieve the improved maintenance profile; and
identify a plurality of sensors to install based on the sensor installation list.

18. The building maintenance improvement system of claim 17, wherein one or more of the energy profile database and the energy allocation database are combined within a single database.

19. The building maintenance improvement system of claim 17, wherein the smart system profile further includes a maintenance schedule.

20. The building maintenance improvement system of claim 17, wherein the building architecture profile includes a building subsystem age;
wherein the one or more memory devices are further configured to store instructions thereon that, when executed by the one or more processors, cause the one or more processors to:
determine a benchmark operational efficiency based on the building subsystem age;
determine a replacement operational efficiency;
provide a recommended replacement time frame based on the benchmark operational efficiency and the replacement operational efficiency.

21. The building maintenance improvement system of claim 17, wherein the one or more memory devices are further configured to store instructions thereon that, when executed by the one or more processors, cause the one or more processors to:
determine an energy efficiency improvement based on the smart system profile.

22. The building maintenance improvement system of claim 17, wherein the one or more memory devices are further configured to store instructions thereon that, when executed by the one or more processors, cause the one or more processors to:
determine a reduction in greenhouse gas emissions based on the smart system profile.

23. The building maintenance improvement system of claim 17, wherein the smart system profile includes a predictive maintenance improvement.

24. A building energy usage improvement system comprising:
one or more memory devices configured to store instructions thereon that, when executed by one or more processors, cause the one or more processors to:
receive building type information, building size information, building age information, and building location information;
generate a building architecture profile based on the building type information, building size information, building age information, and building location information;
query an energy profile database using the building architecture profile and receive an energy profile including estimated energy requirements;
query an energy allocation database using the building architecture profile and the energy profile, and receive a building subsystems benchmark including a heating and cooling energy allocation;
receive an equipment age of a heating ventilation and air conditioning equipment;
determine an equipment energy allocation based on the building subsystems benchmark and the equipment age;
query a lifecycle database using the equipment age and the equipment energy allocation and receive a lifecycle status including profitable, evaluation, diminishing returns, or replace;
determine a recommendation for repair and maintenance, or replacement of the heating ventilation and air conditioning equipment;
determine an improved building subsystems profile based on the recommendation; and
determine an energy savings differential based on the improved building subsystems profile and the building subsystems benchmark.
